(19) United States
(12) Patent Application Publication
(10) Pub. No.: US 2026/0291676 A1
(43) Pub. Date: Sep. 24, 2026

(54) Sequence Initialization for Sidelink Reference Signals

(71) Applicant: Telefonaktiebolaget LM Ericsson (PUBL), Stockholm (SE)

(72) Inventors: Florent MUNIER, VÄSTRA FRÖLUNDA (SE); Ritesh SHREEVASTAV, UPPLANDS VÄSBY (SE); Peter HAMMARBERG, MÖLNDAL (SE)

(21) Appl. No.: 19/473,178

(22) PCT Filed: Apr. 5, 2024
(86) PCT No.: PCT/IB2024/053365

§ 371 Date: Oct. 7, 2025

Related U.S. Application Data
(60) Provisional application No. 63/494,846, filed on Apr. 7, 2023.

(51) Int. Cl. H04L 5/00; H04W 64/00

(52) U.S. Cl. CPC H04L 5/0048; H04W 64/00

(57) ABSTRACT

According to some embodiments, a method performed by a wireless device comprises generating a sidelink (SL) positioning reference signal (PRS) sequence initialization identification (ID). The method further comprises communicating the SL PRS sequence initialization ID to a receiving wireless device. According to some embodiments, another method performed by the wireless device comprises receiving an assigned SL PRS sequence initialization ID from a network node. In such embodiments, the method further comprises communicating the SL PRS sequence initialization ID to a receiving wireless device.

### TECHNICAL FIELD

Embodiments of the present disclosure are directed to wireless communications and, more particularly, to sequence initialization for sidelink reference signals.

### BACKGROUND

In the upcoming release 18 work in Third Generation Partnership Program (3GPP), solutions for sidelink (SL) ranging and positioning will be studied and standardized. Previous standardization work for SL in 3GPP has focused on the communication aspects. From a positioning perspective, the network has been catering for the need for positioning for the cellular system.

### NR Positioning

New radio (NR) currently supports the following radio access technology (RAT) dependent positioning methods:

### DL-TDOA:

The downlink (DL) time-difference-of-arrival (TDOA) positioning method uses the DL reference signal time difference (RSTD) (and optionally DL positioning reference signal (PRS) reference signal received power (RSRP)) of downlink signals received from multiple transmission points (TPs) at the user equipment (UE). The UE measures the DL RSTD (and optionally DL PRS RSRP) of the received signals using assistance data received from the positioning server, and the resulting measurements are used along with other configuration information to locate the UE in relation to the neighboring TPs.

### Multi-RTT:

The Multiple-round trip time (RTT) positioning method uses the UE Rx-Tx measurements and DL PRS RSRP of downlink signals received from multiple TRPs, measured by the UE and the measured gNB (e.g., a network node, a base station) Rx-Tx measurements and uplink (UL) sounding reference signal reference-signal received power (SRS-RSRP) at multiple transmission reception points (TRPs) of uplink signals transmitted from UE.

### UL-TDOA:

The UL TDOA positioning method uses the UL TDOA (and optionally UL SRS-RSRP) at multiple reception points (RPs) of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

### DL-AoD:

The DL angle of departure (AoD) positioning method uses the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

### UL-AoA:

The UL angle of arrival (AoA) positioning method uses the measured azimuth (A) and zenith (Z) of arrival at multiple reception points (RPs) of uplink signals transmitted from the UE. The RPs measure A-AoA and Z-AoA of the received signals using assistance data received from the positioning server, and the resulting measurements are used along with other configuration information to estimate the location of the UE.

### NR-ECID:

NR Enhanced Cell ID (NR E CID) positioning refers to techniques that use additional UE measurements and/or NR radio resource and other measurements to improve the UE location estimate.

The positioning modes may be categorized into three areas:
UE-Assisted: The UE performs measurements with or without assistance from the network and sends these measurements to the evolved serving mobile location center (E-SMLC) where the position calculation may take place.
UE-Based: The UE performs measurements and calculates its own position with assistance from the network.
Standalone: The UE performs measurements and calculates its own position without network assistance.
UE-agnostic: the network performs measurements without UE assistance.

### Sidelink Transmissions in NR

3GPP specified the Long Term Evolution (LTE) D2D (device-to-device) technology, also known as ProSe (Proximity Services) in the Release 12 and 13 of LTE. Later in Rel. 14 and 15, LTE vehicle to everything (V2X) related enhancements targeting the specific characteristics of vehicular communications were specified. 3GPP had started a new work item in August 2018 within the scope of Rel. 16 to develop a new radio (NR) version of V2X communications. The NR V2X mainly targets advanced V2X services, which can be categorized into four use case groups: vehicles platooning, extended sensors, advanced driving and remote driving. The advanced V2X services would require enhancements of the NR system and a new NR sidelink framework could help to meet the stringent requirements in terms of latency and reliability. NR V2X system also expects to have higher system capacity and better coverage and to allow for an easy extension to support the future development of further advanced V2X services and other services.

Given the targeted services by NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service there are certain messages that are only of interest of the members of the platoon, making the members of the platoon a natural groupcast. In another example, the see-through use case most likely involves only a pair of vehicles, for which unicast transmissions naturally fit. Therefore, NR sidelink can support broadcast (as in LTE), groupcast and unicast transmissions. Furthermore, NR sidelink is designed in such a way that its operation is possible with and without network coverage and with varying degrees of interaction between the UEs (user equipment) and the network, including support for standalone, network-less operation.

In 3GPP Rel. 17, discussions took place and National Security and Public Safety, NSPS, is considered to be one important use case, which can benefit from the already developed NR sidelink features in Rel. 16. Therefore, it is most likely that 3GPP will specify enhancements related to network service providers (NSPS) use case taking NR Rel. 16 sidelink as a baseline. In some scenarios NSPS services need to operate with partial or without network coverage, such as indoor firefighting, forest firefighting, earthquake rescue, sea rescue, etc. where the infrastructure is (partially) destroyed or not available, therefore, coverage extension is a crucial enabler for NSPS, for both NSPS services communicated between UE and cellular network and that communicated between UEs over sidelink. In Rel.17, a study item on NR sidelink relay (RP-193253) was launched to further explore coverage extension for sidelink-based communication, including both UE to network relay for cellular coverage extension and UE to UE relay for sidelink coverage extension. Now the work has proceeded to normative phase and in the work item (TR 37.985, Overall description of Radio Access Network (RAN) aspects for Vehicle-to-everything (V2X) based on LTE and NR) only UE to network relay is considered.

In the discussions and planning for NR Rel. 18, sidelink based ranging and positioning has been agreed for standardization. Ranging in general implies that both distance and angle information about the wireless link between two devices is derived. Distance ranging is today available in other standards, e.g., IEEE 802.4z, where in general, a signal exchange is taking place between two devices enabling the round-trip-time (RTT) to be calculated.

### SL Resource Allocation for Communication

Two resource allocations modes for SL communications have been defined in NR:

Mode 1: the UE is in coverage and gNB is scheduling the resources that can be used by UE for SL communications.

Mode 2: the UE, which can be either in coverage or out of coverage, autonomously determines the transmission SL resources within SL resources configured by the gNB or pre-configured by the network.

### Zone Identity Calculation

The UE shall determine an identity of the zone (i.e., Zone_id) in which it is located using the following formulae, if sl-ZoneConfig is configured:

$$x 1 = Floor ( x / L ) Mod 64 ; \qquad Equation ( 1 )$$

$$x 2 = Floor ( y / L ) Mod 64 ; \qquad Equation ( 2 )$$

$$Zone\_id = y 1 * 64 + x 1. \qquad Equation ( 3 )$$

The parameters in the formulas above are defined as follows: L is the value of sl-ZoneLength included in sl-ZoneConfig; x is the geodesic distance in longitude between UE's current location and geographical coordinates (0, 0) and it is expressed in meters; y is the geodesic distance in latitude between UE's current location and geographical coordinates (0, 0) and it is expressed in meters. How the calculated zone_id is used is specified in TS 38.321 ETSI TS 138 214 V17.4.0, “Physical layer procedures for data”, (3GPP TS 38.214 version 17.4.0 Release 17.

### Release 18 WID on SL Positioning

The study phase of SL positioning and ranging in 3GPP release 18 was finalized in 2022. The following specific objectives were agreed to be covered in RP 223549, New WID on Expanded and Improved NR Positioning. As it can be seen, designing the SL PRS and its corresponding resource allocation are among the main objectives.

An objective is to specify solutions for support of sidelink positioning (including ranging) in NR systems. One objective is to specify SL PRS for support of sidelink positioning such that the SL PRS uses a comb-based (full resource element (RE) mapping pattern is not precluded) frequency domain structure and a pseudorandom-based sequence where the existing sequence of DL-PRS is used as a starting point. This may include specifying support for SL PRS bandwidths of up to 100 MHz in frequency range 1 (FR1) spectrum. SL PRS transmission in FR2 is not precluded but no FR2 specific aspects will be specified.

Another objective is to specify measurements to support RTT-type solutions using SL, SL-AoA, and SL-TDOA.

Another objective is to specify support of resource allocation for SL PRS. This includes resource allocation Scheme 1 and Scheme 2, where Scheme 1 corresponds to a network-centric SL PRS resource allocation and Scheme 2 corresponds to UE autonomous SL PRS resource allocation. For resource allocation mechanism for SL PRS in Scheme 2, this includes study and specify support of sensing-based resource allocation, and/or a random resource selection and study and specify solutions for congestion control for SL PRS and/or inter-UE coordination for SL-PRS. This also includes supporting resource allocation for shared resource pool with Rel-16/17/18 sidelink communication and dedicated resource pool for SL PRS. For SL positioning resource (pre-)configuration in a shared resource pool with Rel-16/17/18 sidelink communication, backward compatibility with legacy Rel-16/17 UEs should be ensured.

Another objective is to specify procedures for transmit power control for SL PRS transmissions at least based on open loop power control (OLPC).

Another objective is to specify signaling and associated UE behavior for support of unicast, groupcast (not including many to one) and broadcast of SL PRS transmissions.

Another objective is to specify reporting signaling and procedures to facilitate support of SL positioning in all coverage scenarios and for PC5-only (e.g., direct communication between vehicle and other devices (V2V, V2I) and joint PC5-Uu scenarios (e.g., Uu may refer to air interface). This includes specifying the protocol and procedures for SL positioning between UEs (Protocol for Sidelink positioning procedures (SLPP)) and specifying the protocol and procedures for SL positioning between UEs and location management function (LMF).

Another objective is to specify signaling to next-generation radio access network (NG-RAN) for sidelink positioning and ranging service authorizations as needed.

Another objective is to specify corresponding new core requirements, as well as identifying and specifying the impact on the existing radio resource management (RRM) measurements and procedures.

### Sidelink Positioning Reference Signal

During release 18, a sidelink positioning reference signal (SL-PRS) will be specified. In the work item phase, it was agreed to configure the SL PRS with a sequence initialization similar to the DL PRS. The sequence relies on a higher layer parameter, referred to herein as SL PRS initialization ID. The parameter will have a value between 0 to 4095.

The following include some relevant agreements on the issue. SL PRS sequence is generated based on Gold sequence:

$$r ( n ) = \frac{1}{\sqrt{2}} ( 1 - 2 \cdot c ( n ) ) + j \frac{1}{\sqrt{2}} ( 1 - 2 \cdot c ( 2 n + 1 ) ) \qquad Equation ( 4 )$$

where c(i) is a pseudo-random sequence as defined in Clause 5.2.1 of TS 38.211.

For SL PRS sequence generation, the pseudo-random sequence c(i) initialization equation is defined as a function of at least: slot number, symbol number, and a parameter

$${n}_{ID , seq}^{SL - PRS} .$$

The pseudo-random sequence c (i) initialization equation is based on initialization equation as for DL PRS

For SL PRS sequence generation, consider at least the following options to define the parameter

$${n}_{ID , seq}^{SL - PRS} ,$$

and select one option:
Option 1:

$${n}_{ID , seq}^{SL - PRS}$$

is a higher layer configured parameter
Option 2:

$${n}_{ID , seq}^{SL - PRS}$$

is based on 12 bits cyclic redundancy check (CRC) of physical sidelink control channel (PSCCH) associated with the SL PRS transmission
Option 3: based on a combination of higher layer configured parameter from a configured ID list and 12 bits of CRC of PSCCH associated with the SL PRS transmission
Option 5:

$${n}_{ID , seq}^{SL - PRS}$$

is based on 12 bits least significant bit (LSB) of destination ID
Option 6:

$${n}_{ID , seq}^{SL - PRS}$$

is based on 8 bits of source ID+4 zero bits
Option 7:

$${n}_{ID , seq}^{SL - PRS}$$

is based on the CRC field of the 2nd sidelink control information (SCI) associated with SL PRS transmission, if there is a 2^{nd} SCI defined.

The range of the parameter

$${n}_{ID , seq}^{SL - PRS} is : {n}_{ID , seq}^{SL - PRS} ∈ \{ 0 , 1 , … , 4095 \} .$$

There currently exist certain challenges. For example, the PRS initialization ID for downlink PRS was provided as part of the network configuration. Due to the nature of sidelink, which allows a UE to transmit resources autonomously in mode 2 (also referred to as scheme 2 for the sidelink positioning framework), part of the PRS configuration may be left up to UEs to coordinate between each other.

### SUMMARY

As described above, certain challenges currently exist with the coordination of Positioning Reference Signal (PRS) configuration among User Equipment (UEs) in the context of sidelink (SL) communications, particularly in mode 2 where UEs autonomously manage their resources.

Certain aspects of the disclosure and their embodiments may provide solutions to these or other challenges. For example, some embodiments provide a method for the UE transmitting SL PRS to either obtain the SL PRS initialization ID from the network configuration of a given SL PRS resource, or derive the SL PRS resource initialization ID by itself and share it with the measuring UE.

Further, in some embodiments, the network node may provide mechanisms and parameters for the UE to be able to generate the sequence ID, especially for scenarios when a location management function (LMF) is not available (e.g., out of coverage scenario).

Particular embodiments provide a mechanism for the transmitting UE to either receive a parameter for initialization of a reference signal from the network, or derive its own parameter value and share it with another UE for the purpose of reception.

FIG. 1 is an example flowchart illustrating when a network generates a key and a UE uses the key to generate an SL PRS sequence initialization ID. As shown in FIG. 1, the network may generate the key according to certain embodiments. The network may preconfigure the key to be used by the UE. The network may transmit the key to the UE. The UE may use the key to generate the SL PRS sequence initialization ID according to certain embodiments.

FIG. 2 is an example flowchart illustrating when a network assigns an SL PRS sequence initialization ID that a UE may use. As shown in FIG. 2, the network may assign the SL PRS sequence initialization ID to the UE according to certain embodiments. The network may preconfigure the assigned SL PRS sequence initialization with validity area and validity time according to certain embodiments. The network may transmit the assigned SL PRS sequence initialization ID to the UE. The UE may use the SL PRS sequence initialization ID, for example, for SL communication with another UE.

FIG. 3 is an example flowchart illustrating when a UE generates an SL PRS sequence initialization ID. As shown in FIG. 3, the UE may generate the SL PRS sequence initialization ID according to certain embodiments. The UE may then communicate the SL PRS sequence initialization ID to the network and/or another UE.

According to some embodiments, a method for implementing an SL PRS sequence initialization ID for use in SL PRS configuration is performed by a wireless device (e.g., a UE), the method comprising generating the SL PRS sequence initialization ID. In particular embodiments, the SL PRS sequence initialization ID may be generated when a location management function (LMF) is not available. In particular embodiments, the SL PRS sequence initialization ID may be generated when the wireless device is not connected to a network. The method further comprises communicating the SL PRS sequence initialization ID to a receiving wireless device. In particular embodiments, the method may further comprise communicating the SL PRS sequence initialization ID to a network node.

In particular embodiments, the method may further comprise determining available resources to use for the SL PRS sequence initialization ID prior to generating the SL PRS sequence initialization ID. In particular embodiments, the SL PRS sequence initialization ID may be derived based at least on a location of a resource from among the available resources.

In particular embodiments, the SL PRS sequence initialization ID may override an initial SL PRS sequence initialization ID provided by a network node.

In particular embodiments, the method may further comprise receiving network configuration data from a network node prior to generating the SL PRS sequence initialization ID, where the network configuration data comprises an SL PRS resource configuration, and the SL PRS sequence initialization ID may be determined based at least on the SL PRS resource configuration.

In particular embodiments, the network configuration data may further comprise parameters that enable the wireless device to generate the SL PRS sequence initialization ID. According to some embodiments, a method for implementing an SL PRS sequence initialization ID for use in SL PRS configuration is performed by a wireless device (e.g., a UE), the method comprising receiving an assigned SL PRS sequence initialization ID from a network node. The method further comprises communicating the SL PRS sequence initialization ID to a receiving wireless device.

In particular embodiments, the method may further comprise overriding the assigned SL PRS sequence initialization ID before communicating the SL PRS sequence initialization ID to the receiving wireless device.

In particular embodiments, the SL PRS sequence initialization ID is valid for a certain duration.

In particular embodiments, the SL PRS sequence initialization ID is valid for one or more areas associated with a list of cells and/or sidelink zones.

In particular embodiments, the SL PRS sequence initialization ID is determined based at least on a SL PRS initialization equation, the SL PRS initialization equation is:

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) ) mod {2}^{31}$$

where Cᵢₙᵢₜ is the SL PRS sequence initialization ID,

$${N}_{IDseq}^{PRS}$$

is in the set {0, 1, . . . , 4095},
l is the orthogonal frequency-division multiplexing (OFDM) symbol number within a slot to which the SL PRS sequence initialization ID is mapped,

$${N}_{symb}^{slot}$$

is a number of consecutive OFDM symbols in a slot, and

$${N}_{s , f}^{μ}$$

is a slot number within a frame.

According to some embodiments, a wireless device comprises processing circuitry operable to perform any of the methods of the wireless devices described above.

Also disclosed is a computer program product comprising a non-transitory computer readable medium storing computer readable program code, the computer readable program code operable, when executed by processing circuitry to perform any of the methods performed by the wireless devices described above.

According to some embodiments, a method for implementing an SL PRS sequence initialization ID for use in SL PRS configuration is performed by a network node comprising: generating a key to be used for the SL PRS sequence initialization ID. The method further comprises communicating the key to a first wireless device (e.g., a first UE).

In particular embodiments, the key may be a wireless device-specific key.

In particular embodiments, the key may be valid for a certain time period, and the key is refreshed when the wireless device connects to the network node after the key is expired.

In particular embodiments, the SL PRS sequence initialization ID may be valid for a certain duration.

In particular embodiments, the SL PRS sequence initialization ID may be valid for one or more areas associated with a list of cells and/or sidelink zones.

In particular embodiments, the first wireless device is a transmitting wireless device in a SL communication with a second wireless device (e.g., a second UE).

In particular embodiments, the method may further comprise communicating the key to the second wireless device via a location management function (LMF).

According to some embodiments, a method for implementing an SL PRS sequence initialization ID for use in SL PRS configuration is performed by a network node, the method comprising assigning the SL PRS sequence initialization ID to a first wireless device. The method further comprises communicating the assigned SL PRS sequence initialization ID to the first wireless device.

In particular embodiments, the method may further comprise preconfiguring the assigned SL PRS sequence initialization ID with one or more areas, where the assigned SL PRS sequence initialization ID is valid for the one or more areas associated with a list of cells and/or sidelink zones.

In particular embodiments, the method may further comprise preconfiguring the assigned SL PRS sequence initialization ID with a time period, where the assigned SL PRS sequence initialization ID is valid for the time period.

In particular embodiments, the method may further comprise transmitting a new SL PRS sequence initialization ID to a measuring wireless device when the first wireless device chooses another SL PRS sequence initialization ID different from the assigned SL PRS sequence initialization ID provided by the network node.

According to some embodiments, a network node comprises processing circuitry operable to perform any of the methods of the network nodes described above.

Also disclosed is a computer program product comprising a non-transitory computer readable medium storing computer readable program code, the computer readable program code operable, when executed by processing circuitry to perform any of the methods performed by the network nodes described above.

Certain embodiments may provide one or more of the following technical advantages. For example, some embodiments provide more flexibility for the UE to potentially derive its own value for sequence initialization for scheme 2 transmission and reception of the SL PRS, i.e., for autonomously managed resources. At the same time, the network may help to reduce the probability of ID collision where two UEs select the same sequence. Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is an example flowchart illustrating when a network generates a key and a user equipment (UE) uses the key to generate a sidelink (SL) positioning reference signal (PRS) sequence initialization (ID);

FIG. 2 is an example flowchart illustrating when a network assigns an SL PRS sequence initialization ID that a UE may use;

FIG. 3 is an example flowchart illustrating when a UE generates an SL PRS sequence initialization ID;

FIG. 4 illustrates an example communication system, according to certain embodiments;

FIG. 5 illustrates an example UE, according to certain embodiments;

FIG. 6 illustrates an example network node, according to certain embodiments;

FIG. 7 illustrates a block diagram of a host, according to certain embodiments;

FIG. 8 illustrates a virtualization environment in which functions implemented by some embodiments may be virtualized, according to certain embodiments;

FIG. 9 illustrates a host communicating via a network node with a UE over a partially wireless connection, according to certain embodiments;

FIG. 10 is a flowchart illustrating an example method by a wireless device, according to certain embodiments;

FIG. 11 is a flowchart illustrating another example method by a wireless device, according to certain embodiments;

FIG. 12 is a flowchart illustrating an example method by a network node, according to certain embodiments; and

FIG. 13 is a flowchart illustrating another example method by a network node, according to certain embodiments.

FIG. 14 illustrates an example block diagram of a wireless device, according to certain embodiments; and

FIG. 15 illustrates an example block diagram of a network node, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

The sidelink (SL) positioning reference signal (PRS) initialization equation is based on the SL PRS initialization equation, which is as follows:

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) ) mod {2}^{31} \qquad Equation ( 5 )$$

where Cᵢₙᵢₜ is the SL PRS sequence initialization ID, which, if not provided by higher layers, is obtained from the decimal representation of cyclic redundancy check for the sidelink control information mapped to the PDCCH associated with the SL PRS according to

$${N}_{IDseq}^{PRS} = ( {\sum }_{i = 0}^{L - 1} {p}_{i} \cdot {2}^{L - 1 - i} ) mod {2}^{12}$$

with p and L given by clause 7.3.2 in [4, TS 38.212],

$${N}_{IDseq}^{PRS}$$

is in the set {0, 1, . . . , 4095},
l is the orthogonal frequency-division multiplexing (OFDM) symbol number within a slot to which the SL PRS sequence initialization ID is mapped,

$${N}_{symb}^{slot}$$

is a number of consecutive OFDM symbols in a slot, where

$${N}_{symb}^{slot}$$

depends on the cyclic prefix as given by Tables 4.3.2-1 and 4.3.2-2 in TS38.211 V18.2.0, and

$${N}_{s , f}^{μ}$$

is a slot number within a frame.

The SL PRS will also configure a SL PRS sequence initialization ID between 0 and 4095.

The corresponding description below describes how the SL PRS sequence initialization ID is provided based on what resource allocation scheme the SL PRS is configured for. Two schemes are considered:
Scheme 1, similar to mode 1, is for SL PRS resource configurations used for network-based resource allocation.
Scheme 2, similar to mode 2, is for SL PRS resource configuration used for UE autonomous resource allocation.

In some embodiments, the SL PRS sequence initialization ID may be provided by the gNB as part of the SL PRS configuration for scheme 1 and/or scheme 2 SL PRS resources.

In some embodiments, the parameter may be provided as part of the resource configuration, both to the transmitting user equipment (UE) directly from the gNB, and to the listening UE either via the location management function (LMF) relaying the configuration, or the transmitting UE's higher layer, depending on whether the LMF is assisting the positioning procedure or not. In some embodiments, the SL PRS sequence initialization ID provided by the gNB may be overridden by the transmitting UE, which instead uses a sequence ID derived by the UE's own implementation, but still within the agreed range for the parameter.

In some embodiments, if the LMF is involved, the LMF may be notified by the transmitting UE that it uses an SL PRS sequence initialization ID different from the one provided by the gNB. The LMF then may update the listening UE with the new sequence ID.

In some embodiments, for UE-based positioning (i.e., when the LMF is not involved), the UE may indicate to the listening UE the new sequence ID derived by the transmitting UE.

In some embodiments, the indicated sequence ID (either by LMF or UE) may be valid for a certain duration and/or certain validity area (list of cells, sidelink zones, etc.).

In some embodiments, the network node such as LMF/gNB may pre-configure the sequence ID or key on how to generate the sequence ID. The pre-configuration parameters may further differ for which coverage the UE is in: in coverage, partial coverage or out of coverage. Alternatively or additionally, in some embodiments, the SL PRS sequence initialization ID may be omitted from the SL PRS configuration for scheme 1 and/or scheme 2 SL PRS resources. In such embodiments, the UE may select the SL PRS resource initialization ID on its own, and update the LMF and listening UEs similarly to the steps described above.

### Network-Assisted Sequence ID Generation

In some embodiments, the network node such as the location server or base station, provides a key to the UE that is a UE-specific key. This may be provided to a SL-capable UE when the UE connects to the network. In some embodiments, the key may be valid for a certain time period; i.e., the key may be refreshed when the UE connects to the network after the expiry of the key validity time. The UE may perform an operation with the key and use the SL L2ID when it is in an out-of-coverage scenario. The operation may include XOR, AND, shift operations, etc. and converting the result into an integer number from 1 to 4096 to be used for sequence ID.

An example: L2ID XOR Key=110000110 XOR 1001010=Result. Truncate the result to the most significant bit (MSB) of 12 bits and convert the result into an integer and use the value as sequence ID. If the result is less than 12 bits; then the network may further provide the rule as to whether UE appends “0” to the end (LSB) or appends at the start (MSB).

### UE Autonomous Actions (Selection)

In some embodiments, the UE may be configured with a set of IDs to autonomously choose from. The set may, for example, be formed by the N most or least significant bits, and with the other 12-N bits provided by the network.

In some embodiments, when the UE performs a sensing procedure to sense available resources and further select the resources; the sequence ID to be used may be derived based upon the location of the resource that was selected; i.e., some characteristics based upon the physical resource block (PRB) ID and system frame number (SFN) time or the characteristics based upon frequency and/or time location of the resource.

$$Sequence ID = function ( reserved Frequency and / or time ) \qquad Equation ( 6 )$$

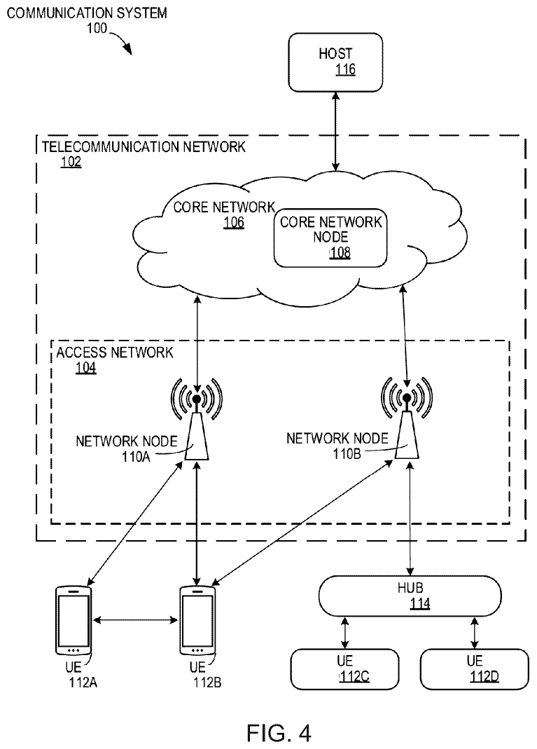

FIG. 4 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

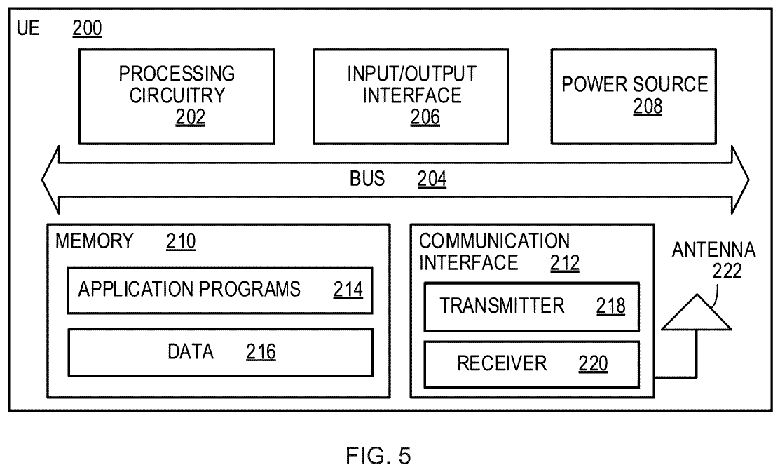

FIG. 5 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as is Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

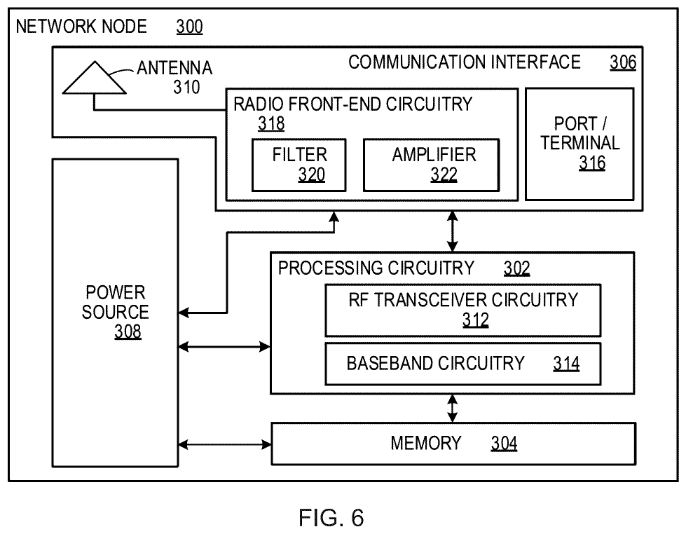

FIG. 6 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 6 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

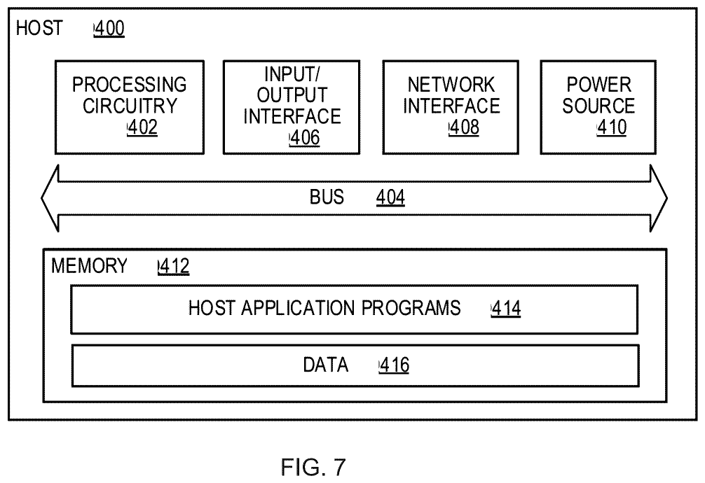

FIG. 7 is a block diagram of a host 400, which may be an embodiment of the host 116 of FIG. 4, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 4 and 5, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

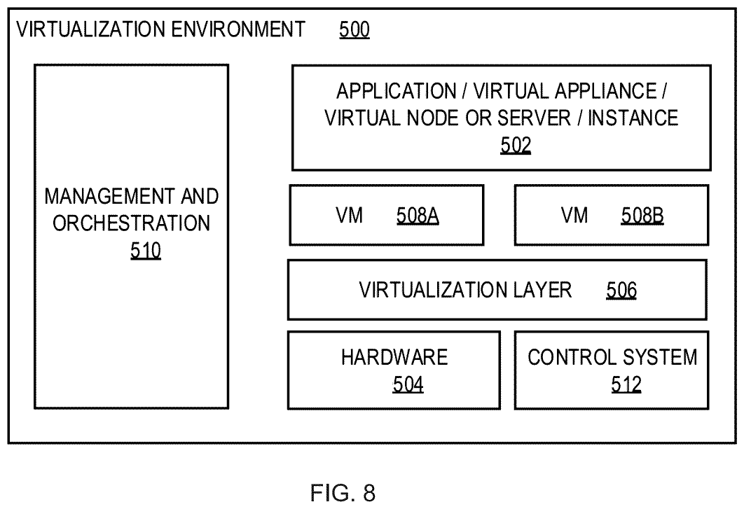

FIG. 8 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

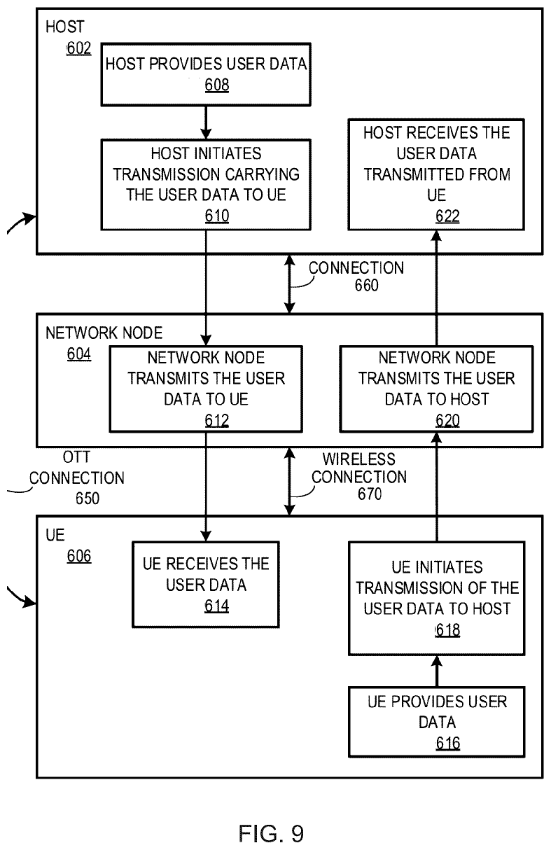

FIG. 9 shows a communication diagram of a host 602 communicating via a network node 604 with a UE 606 over a partially wireless connection in accordance with some embodiments. Example implementations, in accordance with various embodiments, of the UE (such as a UE 112a of FIG. 4 and/or UE 200 of FIG. 5), network node (such as network node 110a of FIG. 4 and/or network node 300 of FIG. 6), and host (such as host 116 of FIG. 4 and/or host 400 of FIG. 7) discussed in the preceding paragraphs will now be described with reference to FIG. 9.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 4) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the UE location verification in NTN and thereby provide benefits such as improved beam signaling, beam forming, etc.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

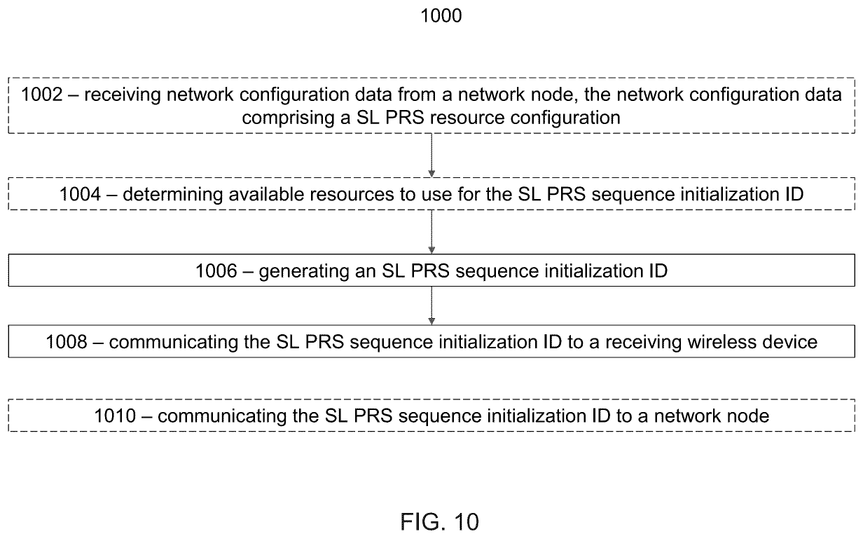

FIG. 10 is a flowchart illustrating an example method in a wireless device for implementing an SL PRS sequence initialization ID for use in SL PRS configuration, according to certain embodiments. In particular embodiments, one or more steps of FIG. 10 may be performed by UE 200 described with respect to FIG. 5.

The method may begin at the optional step 1002, where the wireless device (e.g., UE 200) may receive network configuration data from a network node, the network configuration data comprising a SL PRS resource configuration. In particular embodiments, the SL PRS sequence initialization ID may be determined based at least on the SL PRS resource configuration.

In particular embodiments, the network configuration data may further comprise parameters that enable the wireless device to generate the SL PRS sequence initialization ID.

At the optional step 1004, the wireless device may determine available resources to use for the SL PRS sequence initialization ID. In particular embodiments, the SL PRS sequence initialization ID may be derived based at least on a location of a resource from among the available resources.

At step 1006, the wireless device generates the SL PRS sequence initialization ID. In particular embodiments, the SL PRS sequence initialization ID is generated when a location management function (LMF) is not available. In particular embodiments, the SL PRS sequence initialization ID is generated when the wireless device is not connected to a network. At step 1008, the wireless device communicates the SL PRS sequence initialization ID to a receiving wireless device. At the optional step 1010, the wireless device may communicate the SL PRS sequence initialization ID to a network node. In particular embodiments, the SL PRS sequence initialization ID overrides an initial SL PRS sequence initialization ID provided by a network node.

Modifications, additions, or omissions may be made to method 1000. Additionally, one or more steps in the method 1000 may be performed in parallel or in any suitable order.

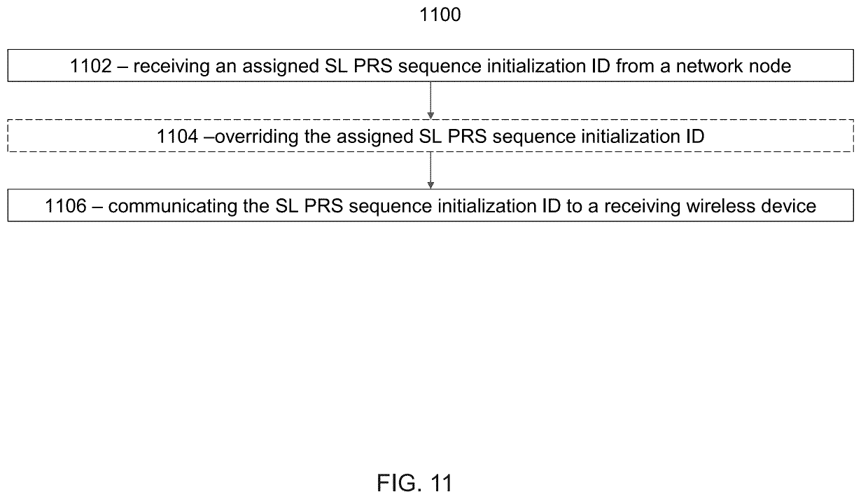

FIG. 11 is a flowchart illustrating another example method in a wireless device for implementing an SL PRS sequence initialization ID for use in SL PRS configuration, according to certain embodiments. In particular embodiments, one or more steps of FIG. 11 may be performed by UE 200 described with respect to FIG. 5.

The method may begin at step 1102, where the wireless device (e.g., UE 200) receives an assigned SL PRS sequence initialization ID from a network node.

At optional step 1104, the wireless device may override the assigned SL PRS sequence initialization ID, for example, with another SL PRS sequence initialization ID.

At step 1106, the wireless device communicates the SL PRS sequence initialization ID to a receiving wireless device.

In particular embodiments, the SL PRS sequence initialization ID may be valid for a certain duration.

In particular embodiments, the SL PRS sequence initialization ID may be valid for one or more areas associated with a list of cells and/or sidelink zones.

In particular embodiments, the SL PRS sequence initialization ID may be determined based at least on a SL PRS initialization equation, the SL PRS initialization equation is:

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) ) mod {2}^{31} \qquad Equation ( 5 )$$

where Cᵢₙᵢₜ is the SL PRS sequence initialization ID,

$${N}_{IDseq}^{PRS}$$

is in the set {0, 1, . . . , 4095},
l is the orthogonal frequency-division multiplexing (OFDM) symbol number within a slot to which the SL PRS sequence initialization ID is mapped,

$${N}_{symb}^{slot}$$

is a number of consecutive OFDM symbols in a slot, and

$${N}_{s , f}^{μ}$$

is a slot number within a frame.

In particular embodiments, any of the steps and embodiments described with respect to the method 1000 in FIG. 10 may be implemented in conjunction with any of the steps and embodiments described with respect to the method 1100 in FIG. 11, and vice versa.

Modifications, additions, or omissions may be made to method 1100. Additionally, one or more steps in the method 1100 may be performed in parallel or in any suitable order.

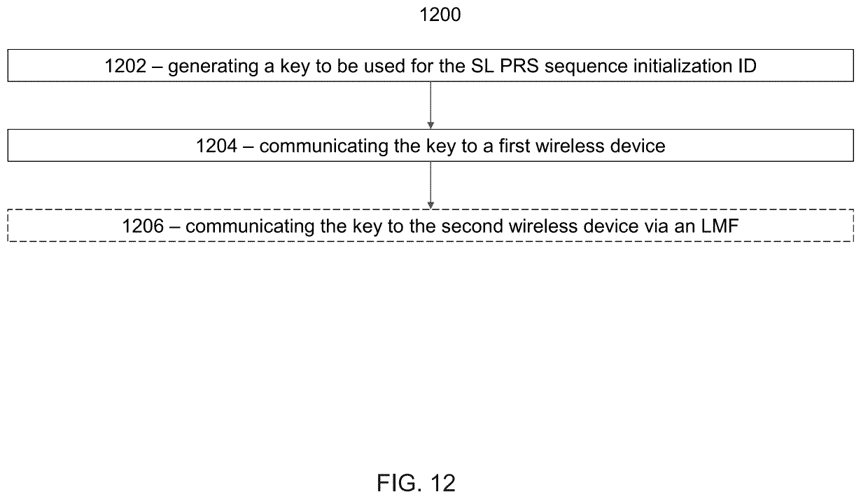

FIG. 12 is a flowchart illustrating an example method in a network node for implementing an SL PRS sequence initialization ID for use in SL PRS configuration, according to certain embodiments. In particular embodiments, one or more steps of FIG. 12 may be performed by network node 300 described with respect to FIG. 6.

The method begins at step 1202, where the network node (e.g., network node 300) generates a ley to be used for the SL PRS sequence initialization ID. At step 1204, the network node communicates the key to a first wireless device (e.g., a first instance of UE 200 of FIG. 5).

At optional step 1206, the network node may communicate the key to a second wireless device (e.g., a second instance of UE 200 of FIG. 5) via an LMF. In particular embodiments, the first wireless device is a transmitting wireless device in an SL communication with the second wireless device.

In particular embodiments, the key may be a wireless device-specific key. In particular embodiments, the key may be valid for a certain time period, and the key may be refreshed when the wireless device connects to the network node after the key is expired.

In particular embodiments, the SL PRS sequence initialization ID may be valid for a certain duration. In particular embodiments, the SL PRS sequence initialization ID may be valid for one or more areas associated with a list of cells and/or sidelink zones.

Modifications, additions, or omissions may be made to method 1200. Additionally, one or more steps in the method 1200 may be performed in parallel or in any suitable order.

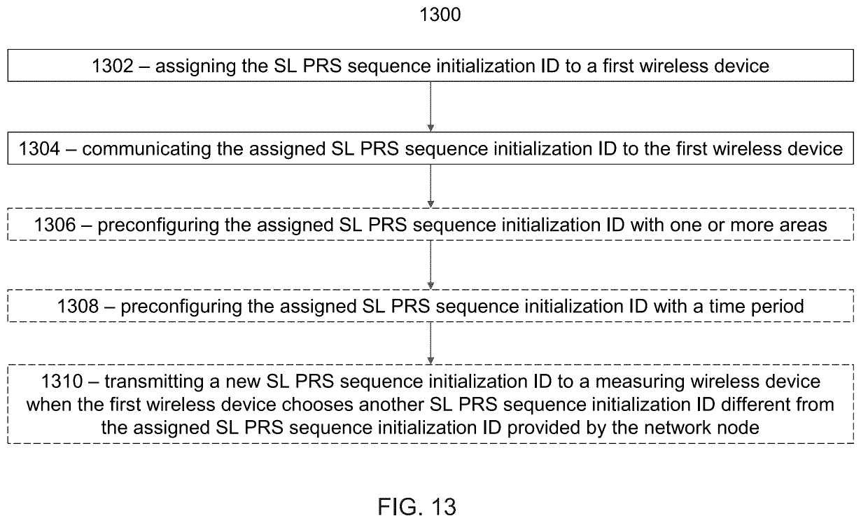

FIG. 13 is a flowchart illustrating another example method in a network node for implementing an SL PRS sequence initialization ID for use in SL PRS configuration, according to certain embodiments. In particular embodiments, one or more steps of FIG. 13 may be performed by network node 1300 described with respect to FIG. 6.

The method begins at step 1302, where the network node (e.g., network node 300) assigns the SL PRS sequence initialization ID to a first wireless device (e.g., a first instance of UE 200 of FIG. 5).

At step 1304, the network node communicates the assigned SL PRS sequence initialization ID to the first wireless device.

At optional step 1306, the network node may preconfigure the assigned SL PRS sequence initialization ID with one or more areas, where the assigned SL PRS sequence initialization ID may be valid for the one or more areas associated with a list of cells and/or sidelink zones.

At optional step 1308, the network node may preconfigure the assigned SL PRS sequence initialization ID with a time period, where the assigned SL PRS sequence initialization ID may be valid for the time period.

At optional step 1310, the network node may transmit a new SL PRS sequence initialization ID to a measuring wireless device (e.g., second instance of UE 200 of FIG. 5) when the first wireless device chooses another SL PRS sequence initialization ID different from the assigned SL PRS sequence initialization ID provided by the network node.

In particular embodiments, any of the steps and embodiments described with respect to method 1200 in FIG. 12 may be implemented in conjunction with any of the steps and embodiments described with respect to method 1300 in FIG. 13, and vice versa.

Modifications, additions, or omissions may be made to method 1300. Additionally, one or more steps in the method 1300 may be performed in parallel or in any suitable order.

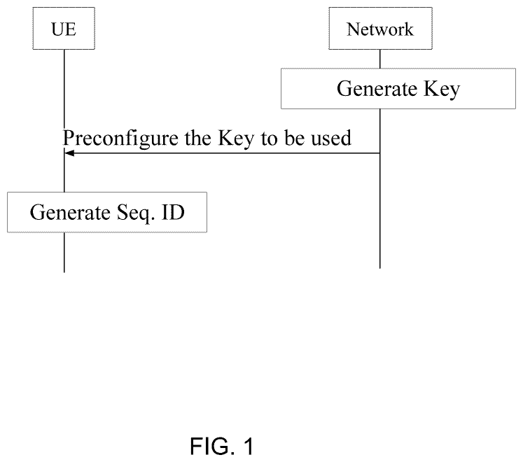

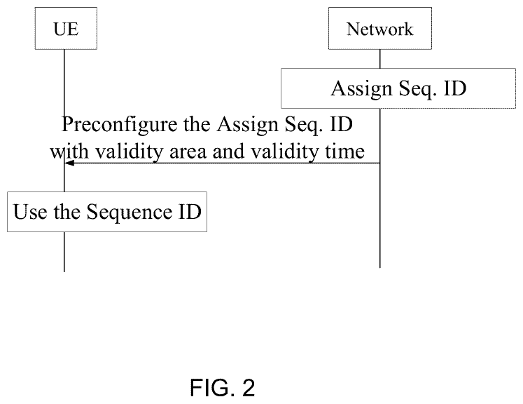

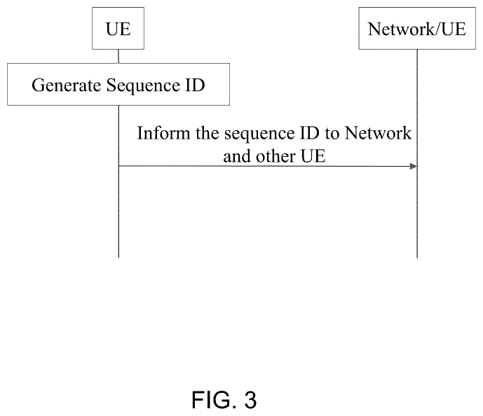

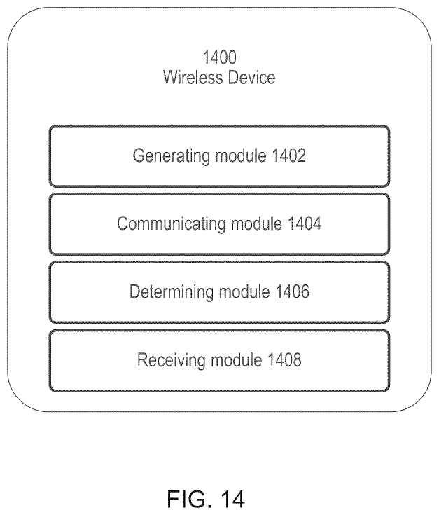

FIG. 14 illustrates a schematic block diagram of a wireless device (for example, the UE 200 illustrated in FIG. 5). The apparatus 1400 includes a wireless node (e.g., UE 200 illustrated in FIG. 5). Apparatus 1400 is operable to carry out the example methods described with reference to FIGS. 1-13 and possibly any other processes or methods disclosed herein. It is also to be understood that the method of FIG. 14 is not necessarily carried out solely by apparatus 1400. At least some operations of any of the method may be performed by one or more other entities.

Virtual apparatus 1400 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause the generating module 1402, communicating module 1404, determining module 1406, and/or any other suitable units of apparatus 1400 to perform corresponding functions according to one or more embodiments of the present disclosure.

As illustrated in FIG. 14, apparatus 1400 includes generating module 1402 configured to generate the SL PRS sequence initialization ID according to any of the embodiments and examples described herein. The communicating module 1404 may be configured to communicate the SL PRS sequence initialization ID to a receiving wireless device (e.g., UE 200 of FIG. 5) according to any of the embodiments and examples described herein. The communicating module 1404 may be further configured to communicate the SL PRS sequence initialization ID to a network node (e.g., network node 300 of FIG. 6) according to any of the embodiments and examples described herein. The determining module 1406 may be configured to determine available resources to use for the SL PRS sequence initialization ID according to any of the embodiments and examples described herein. In particular embodiments, the SL PRS sequence initialization ID may be derived based at least on a location of a resource from among the available resources. The receiving module 1408 may be configured to receive network configuration data from a network node, the network configuration data comprising a SL PRS resource configuration according to any of the embodiments and examples described herein. In particular embodiments, the SL PRS sequence initialization ID may be determined based at least on the SL PRS resource configuration.

The receiving module 1408 may be further configured to receive an assigned SL PRS sequence initialization ID from a network node (e.g., network node 300 of FIG. 6) according to any of the embodiments and examples described herein. The communicating module 1404 may be further configured to communicate the SL PRS sequence initialization ID to a receiving wireless device (e.g., UE 200 of FIG. 5) according to any of the embodiments and examples described herein. The determining module 1406 may be further configured to override the assigned SL PRS sequence initialization ID before the SL PRS sequence initialization ID is communicated to the receiving wireless device according to any of the embodiments and examples described herein.

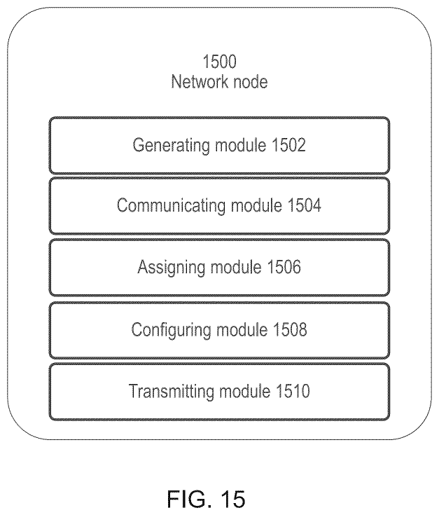

FIG. 15 illustrates a schematic block diagram of a network node (for example, the network node 300 illustrated in FIG. 6). The apparatus 1500 includes a network node (e.g., network node 300 illustrated in FIG. 6). Apparatus 1500 is operable to carry out the example methods described with reference to FIGS. 1-14 and possibly any other processes or methods disclosed herein. It is also to be understood that the method of FIG. 15 is not necessarily carried out solely by apparatus 1500. At least some operations of any of the method may be performed by one or more other entities.

Virtual apparatus 1500 may comprise processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause generating module 1502, communicating module 1504, assigning module 1506, configuring module 1508, transmitting module 1510, and/or nay other suitable units of apparatus 1500 to perform corresponding functions according to one or more embodiments of the present disclosure.

As illustrated in FIG. 15, apparatus 1500 includes generating module 1502 configured to generate a key to be used for the SL PRS sequence initialization ID according to any of the embodiments and examples described herein. The communicating module 1504 may be configured to communicate the key to a first wireless device (e.g., a first instance of UE 200 of FIG. 5) according to any of the embodiments and examples described herein. The communicating module 1504 may be further configured to communicate the key to a second wireless device (e.g., a second instance of UE 200 of FIG. 5) via an LMF according to any of the embodiments and examples described herein. In particular embodiments, the first wireless device is a transmitting wireless device in an SL communication with the second wireless device.

The assigning module 1506 may be configured to assign the SL PRS sequence initialization ID to a first wireless device (e.g., a first instance of UE 200 of FIG. 5) according to any of the embodiments and examples described herein. The communicating module 1508 may be configured to communicate the assigned SL PRS sequence initialization ID to the first wireless device according to any of the embodiments and examples described herein. The configuring module 1508 may be configured to preconfigure the assigned SL PRS sequence initialization ID with one or more areas, where the assigned SL PRS sequence initialization ID may be valid for the one or more areas associated with a list of cells and/or sidelink zones according to any of the embodiments and examples described herein. The configuring module 1508 may be further configured to preconfigure the assigned SL PRS sequence initialization ID with a time period, where the assigned SL PRS sequence initialization ID may be valid for the time period according to any of the embodiments and examples described herein. The transmitting module 1310 may be configured to transmit a new SL PRS sequence initialization ID to a measuring wireless device when the first wireless device chooses another SL PRS sequence initialization ID different from the assigned SL PRS sequence initialization ID provided by the network node according to any of the embodiments and examples described herein.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Some example embodiments include the following:

### Group A Embodiments

1. A method performed by a user equipment for implementing a sidelink (SL) positioning reference signals (PRS) sequence initialization identification (ID) for use in SL PRS configuration, the method comprising:
generating the SL PRS sequence initialization ID; and
communicating the SL PRS sequence initialization ID to a receiving user equipment.

2. The method of the previous embodiment, further comprising communicating the SL PRS sequence initialization ID to a network node.

3. The method of any one of the previous embodiments, further comprising:
prior to generating the SL PRS sequence initialization ID, determining available resources to use for the SL PRS sequence initialization ID, wherein the SL PRS sequence initialization ID is derived based at least on a location of a resource from among the available resources.

4. The method of any one of the previous embodiments, wherein the SL PRS sequence initialization ID is overridden over an initial SL PRS sequence initialization ID provided by a network node.

5. A method performed by a user equipment for implementing a sidelink (SL) positioning reference signals (PRS) sequence initialization identification (ID) for use in SL PRS configuration, the method comprising:
receiving an assigned SL PRS sequence initialization ID from a network node; and communicating the SL PRS sequence initialization ID to a receiving user equipment.

6. The method of the previous embodiment, further comprising overriding the received SL PRS sequence initialization ID before communicating to the receiving use equipment.

7. The method of any one of the previous embodiments, wherein the SL PRS sequence initialization ID is valid for a certain duration.

8. The method of any one of the previous embodiments, wherein the SL PRS sequence initialization ID is valid for one or more areas associated with a list of cells and/or sidelink zones.

9. The method of any of the previous embodiments, wherein the SL PRS sequence initialization ID is determined based at least on a SL PRS initialization equation, the SL PRS initialization equation is:

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) ) mod {2}^{31} . \qquad Equation ( 5 )$$

10. A method performed by a wireless device, the method comprising:
any of the wireless device steps, features, or functions described above, either alone or in combination with other steps, features, or functions described above.

11. The method of the previous embodiment, further comprising one or more additional wireless device steps, features or functions described above.

12. The method of any of the previous embodiments, further comprising:
providing user data; and
forwarding the user data to a host via the transmission to the network node.

### Group B Embodiments

13. A method performed by a network node for implementing a sidelink (SL) positioning reference signals (PRS) sequence initialization identification (ID) for use in SL PRS configuration, the method comprising:
generating a key to be used for the SL PRS sequence initialization ID; and
communicating the key to a first user equipment.

14. The method of the previous embodiment, wherein the key is a user equipment-specific key.

15. The method of the previous embodiment, wherein the key is valid for a certain time period, the key is refreshed when the user equipment connects to the network node after the key is expired.

16. The method of any one of the previous embodiments, wherein the SL PRS sequence initialization ID is valid for a certain duration.

17. The method of any one of the previous embodiments, wherein the SL PRS sequence initialization ID is valid for one or more areas associated with a list of cells and/or sidelink zones.

18. The method of any one of the previous embodiments, wherein the first user equipment is a transmitting user equipment in a SL communication with a second user equipment.

19. The method of the previous embodiment, further comprising communicating the key to the second user equipment via a location management function (LMF).

20. A method performed by a network node, the method comprising:
any of the network node steps, features, or functions described above, either alone or in combination with other steps, features, or functions described above.

21. The method of the previous embodiment, further comprising one or more additional network node steps, features or functions described above.

22. The method of any of the previous embodiments, further comprising:
obtaining user data; and
forwarding the user data to a host or a user equipment.

### Group C Embodiments

23. A user equipment for implementing a sidelink (SL) positioning reference signals (PRS) sequence initialization identification (ID) for use in SL PRS configuration, comprising:
processing circuitry configured to perform any of the steps of any of the Group A embodiments; and
power supply circuitry configured to supply power to the processing circuitry.

24. A network node for implementing a sidelink (SL) positioning reference signals (PRS) sequence initialization identification (ID) for use in SL PRS configuration, the network node comprising:
processing circuitry configured to perform any of the steps of any of the Group B embodiments;
power supply circuitry configured to supply power to the processing circuitry.

25. A user equipment (UE) for implementing a sidelink (SL) positioning reference signals (PRS) sequence initialization identification (ID) for use in SL PRS configuration, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

26. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

27. The host of the previous embodiment, wherein the cellular network further includes a network node configured to communicate with the UE to transmit the user data to the UE from the host.

28. The host of the previous 2 embodiments, wherein:
the processing circuitry of the host is configured to execute a host application, thereby providing the user data; and
the host application is configured to interact with a client application executing on the UE, the client application being associated with the host application.

29. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

30. The method of the previous embodiment, further comprising:
at the host, executing a host application associated with a client application executing on the UE to receive the user data from the UE.

31. The method of the previous embodiment, further comprising:
at the host, transmitting input data to the client application executing on the UE, the input data being provided by executing the host application,
wherein the user data is provided by the client application in response to the input data from the host application.

32. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

33. The host of the previous embodiment, wherein the cellular network further includes a network node configured to communicate with the UE to transmit the user data from the UE to the host.

34. The host of the previous 2 embodiments, wherein:
the processing circuitry of the host is configured to execute a host application, thereby providing the user data; and
the host application is configured to interact with a client application executing on the UE, the client application being associated with the host application.

35. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

36. The method of the previous embodiment, further comprising:
at the host, executing a host application associated with a client application executing on the UE to receive the user data from the UE.

37. The method of the previous embodiment, further comprising:
at the host, transmitting input data to the client application executing on the UE, the input data being provided by executing the host application,
wherein the user data is provided by the client application in response to the input data from the host application.

38. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

39. The host of the previous embodiment, wherein:
the processing circuitry of the host is configured to execute a host application that provides the user data; and
the UE comprises processing circuitry configured to execute a client application associated with the host application to receive the transmission of user data from the host.

40. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

41. The method of the previous embodiment, further comprising, at the network node, transmitting the user data provided by the host for the UE.

42. The method of any of the previous 2 embodiments, wherein the user data is provided at the host by executing a host application that interacts with a client application executing on the UE, the client application being associated with the host application.

43. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

44. The communication system of the previous embodiment, further comprising:
the network node; and/or
the user equipment.

45. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

46. The host of the previous 2 embodiments, wherein:
the processing circuitry of the host is configured to execute a host application, thereby providing the user data; and
the host application is configured to interact with a client application executing on the UE, the client application being associated with the host application.

47. The host of the any of the previous 2 embodiments, wherein the initiating receipt of the user data comprises requesting the user data.

48. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

49. The method of the previous embodiment, further comprising at the network node, transmitting the received user data to the host.

1. A method performed by a wireless device for implementing a sidelink (SL) positioning reference signal (PRS) sequence initialization identification (ID) for use in SL PRS configuration, the method comprising:
generating the SL PRS sequence initialization ID; and
communicating the SL PRS sequence initialization ID to a receiving wireless device.

2. The method of claim 1, further comprising communicating the SL PRS sequence initialization ID to a network node.

3. The method claim 1, further comprising:
prior to generating the SL PRS sequence initialization ID, determining available resources to use for the SL PRS sequence initialization ID, wherein the SL PRS sequence initialization ID is derived based at least on a location of a resource from among the available resources.

4. The method of claim 1, wherein the SL PRS sequence initialization ID overrides an initial SL PRS sequence initialization ID provided by a network node.

5. The method of claim 1, wherein the SL PRS sequence initialization ID is generated when a location management function (LMF) is not available.

6. The method of claim 1, further comprising:
prior to generating the SL PRS sequence initialization ID, receiving network configuration data from a network node, the network configuration data comprising a SL PRS resource configuration, wherein the SL PRS sequence initialization ID is determined based at least on the SL PRS resource configuration.

7. The method of claim 6, wherein the network configuration data further comprises parameters that enable the wireless device to generate the SL PRS sequence initialization ID.

8. The method of claim 1, wherein the SL PRS sequence initialization ID is generated when the wireless device is not connected to a network.

9. A method performed by a wireless device for implementing a sidelink (SL) positioning reference signal (PRS) sequence initialization identification (ID) for use in SL PRS configuration, the method comprising:
receiving an assigned SL PRS sequence initialization ID from a network node; and
communicating the SL PRS sequence initialization ID to a receiving wireless device.

10. The method of claim 9, further comprising overriding the assigned SL PRS sequence initialization ID before communicating the SL PRS sequence initialization ID to the receiving wireless device.

11.-13. (canceled)

14.-24. (canceled)

25. A wireless device capable of implementing a sidelink (SL) positioning reference signal (PRS) sequence initialization identification (ID) for use in SL PRS configuration, the wireless device having a processing circuitry configured to:
generate the SL PRS sequence initialization ID; and
communicate the SL PRS sequence initialization ID to a receiving wireless device.

26. The wireless device of claim 25, wherein the wireless device is further configured to communicate the SL PRS sequence initialization ID to a network node.

27. The wireless device of claim 25, wherein the wireless device is further configured to:
prior to generating the SL PRS sequence initialization ID, determine available resources to use for the SL PRS sequence initialization ID, wherein the SL PRS sequence initialization ID is derived based at least on a location of a resource from among the available resources.

28. The wireless device of claim 25, wherein the SL PRS sequence initialization ID overrides an initial SL PRS sequence initialization ID provided by a network node.

29. The wireless device of claim 25, wherein the SL PRS sequence initialization ID is generated when a location management function (LMF) is not available.

30. The wireless device of claim 25, wherein the wireless device is further configured to:
prior to generating the SL PRS sequence initialization ID, receive network configuration data from a network node, the network configuration data comprising an SL PRS resource configuration, wherein the SL PRS sequence initialization ID is determined based at least on the SL PRS resource configuration.

31.-32. (canceled)

33. A wireless device capable of implementing a sidelink (SL) positioning reference signal (PRS) sequence initialization identification (ID) for use in SL PRS configuration, the wireless device having a processing circuitry configured to:
receive an assigned SL PRS sequence initialization ID from a network node; and
communicate the SL PRS sequence initialization ID to a receiving wireless device.

34.-45. (canceled)

46. The network node of claim 33 wherein the network node is further configured to preconfigure the assigned SL PRS sequence initialization ID with one or more areas, wherein the assigned SL PRS sequence initialization ID is valid for the one or more areas associated with a list of cells and/or sidelink zones.

47. The network node of claim 33 wherein the network node is further configured to preconfigure the assigned SL PRS sequence initialization ID with a time period, wherein the assigned SL PRS sequence initialization ID is valid for the time period.

48. The network node of claim 33, wherein the network node is further configured to transmit a new SL PRS sequence initialization ID to a measuring wireless device when the first wireless device chooses another SL PRS sequence initialization ID different from the assigned SL PRS sequence initialization ID provided by the network node.
